(19) United States
(12) Patent Application Publication
(10) Pub. No.: US 2008/0265767 A1
(43) Pub. Date: Oct. 30, 2008

(54) Electroluminescent Cable and Method of Fabrication Thereof

(76) Inventors: Israel Baumberg, Maaleh Adumim (IL); Oleg Berezin, Maaleh Adumim (IL); Boris Gorelik, Zur-Hadassa (IL); Moshe Voskoboinik, Maale Adumim (IL)

Correspondence Address: Pearl Cohen Zedek Latzer, LLP, 1500 Broadway, 12th Floor, New York, NY, 10036, US

(21) Appl. No.: 11/994,836

(22) PCT Filed: Jul. 4, 2006
(86) PCT No.: PCT/IL06/00774

§ 371 Date: Jan. 6, 2008

(30) Foreign Application Priority Data
Jul. 6, 2005 (IL) 169547

(51) Int. Cl. H01J 63/04

(52) U.S. Cl. 313/511

(57) ABSTRACT

Electroluminescent cable (10) and method of fabrication thereof. For example, an electroluminescent cable (10) includes a composite core electrode including an elongated flexible metal portion (2) substantially surrounded by one or more layers of a flexible conductive compound (4), the composite core electrode surrounded by a dielectric layer (6), an electroluminescent layer (8), a transparent conductive layer (12) and a polymer layer (16).

### FIELD OF THE INVENTION

The present invention relates generally to electroluminescent light sources and, more particularly, to flexible elongate electroluminescent light sources.

### BACKGROUND OF THE INVENTION

Some flexible extended electroluminescent light sources are known in the art, for example, electroluminescent wire, electroluminescent filament, electroluminescent cable, electroluminescent strip, electroluminescent welt, etc.

Some flexible extended electroluminescent light sources may include a metal core electrode having consecutively applied thereto a dielectric layer, an electroluminescent layer, an electroconductive transparent layer functioning as an external electrode, and one or more polymer layers isolating the structure from the ambient space and coloring the emitted light in various colors.

When an alternating voltage, having a suitable frequency and amplitude, is applied to the core and external electrodes, the electroluminescent layer emits light that passes through the transparent electrode.

Such flexible extended electroluminescent light sources are described in U.S. Pat. No. 3,069,579 to Berg; U.S. Pat. No. 5,485,355 to Voskoboinik; U.S. Pat. No. 5,869,930 to Baumberg; U.S. Pat. No. 6,082,867 to Chien; and U.S. Pat. No. 6,400,093 to Baumberg. In the flexible extended electroluminescent light sources described in the above-mentioned patents, a metal wire is used as the core electrode; the thickness and filling of dielectric and electroluminescent layers are optimized for the specified frequency and amplitude of the electric signal, and the only way to increase the amount of light emitted by the light source is by increasing the area of the light-emitting layer. However, within the framework of the above-mentioned patents, this may be achieved only by increasing the diameter of the core wire electrode, which may result in a drastic increase of the weight of the facility and/or a simultaneous decrease in its flexibility.

### SUMMARY OF THE INVENTION

In some embodiments of the invention, an electroluminescent (EL) cable may include, for example, a composite core electrode consisting of one or several metal (e.g., copper) wires passing through a conductive compound layer. The conductive compound layer may be or may include, for example, a dispersion of powders of electroconductive particles in a polymer. Such particles may include, for instance, metal particles, carbon black particles, carbon nanotubes, doped semiconductor particles, microscopic glass beads or mica plates coated with electroconductive layer, or other suitable particles or materials. The polymer for the conductive compound may be selected from one or more groups of polymers, for example, polyolefines, fluorocarbon polymers, polyamides, polyurethanes, or the like. Other suitable materials may be used.

In some embodiments, a dielectric layer, an electroluminescent layer and a transparent electroconductive layer functioning as an external electrode may be consecutively applied on the above-mentioned composite core electrode. In some embodiments, along substantially the entire length of the EL cable, a wire contact may adjoin the transparent electroconductive layer and/or may be pressed thereto by the external polymer layer.

Some embodiments may allow, for example, an EL cable having a large area of light-emitting surface, while retaining a high flexibility and low weight of the cable.

In some embodiments, a composite core electrode may be produced by an extrusion method, which may allow production of electrodes having various cross-section shapes. For example, a composite core electrode having an elliptical cross-section may be produced using this method. In some embodiments, an EL cable with a composite core electrode of such cross-section shape, or other suitable cross-section shapes or properties, may emit considerably more light than an EL cable having a cylindrical core electrode of the same cross-section and/or the same weight, e.g., due to an increased light emission area.

In some embodiments, some anisotropy of light emission may be of no significant importance for many applications. However, anisotropy of light emission may be significantly reduced, for example, by introducing diffusion particles that increase light scattering into the external polymer layer of the EL cable.

In some embodiments, an additional increase in the amount of emitted light may be achieved by introducing particles having a high Reflectance Index (RI), into the surface layer of the composite core electrode, for example, particles having a RI value greater than 2.0, e.g., titanium dioxide particles (having a RI value of 2.7), or the like. A similar effect may be achieved by utilizing a thin, highly reflective layer having a high dielectric permittivity, which may be applied to the surface of the composite core electrode.

In some embodiments, an EL wire or cable may be utilized for fastening to one or more planes, for example, to a vertical surface (e.g., a wall). For example, a composite core electrode having a shape close to a semi-cylinder (and respectively, a cross-section close to a semi-circle) may be used. The composite core electrode may be coated (e.g., substantially entirely) with a dielectric layer, and may be further coated (e.g., partially) with an electroluminescent layer. In some embodiments, for example, the flat part of the dielectric layer may not be coated with the electroluminescent layer. Thereafter, substantially the entire surface of the partially electroluminescent-coated dielectric may be coated with a transparent electroconductive layer, thereby enabling a wire contact to adjoin, for example, only the flat or non-electroluminescenting part of the transparent electroconductive layer. The external polymer layer may coat and conform to the shape of the core electrode, and the flat part of the core electrode may be approximately parallel to the flat part of the external polymer layer. The EL cable may be fastened to a surface, for example, utilizing its flat part. The shape of the composite core electrode may be semi-cylindrical, and the entire EL cable may be considerably lighter. The amount of light around 180 degrees may be practically the same as in the case of a cylindrical core electrode. In some embodiments, such EL cables may be considerably cheaper, for example, since a relatively expensive electroluminescent layer may be applied only to the part of the light-emitting surface within the angle of 180 degrees, and need not be applied to the flat face.

In some embodiments, using composite core electrodes may allow production of EL cables in the form of, for example, a flexible ribbon of any arbitrary width. For example, several spaced-apart copper wires, for example, equally spaced, may be arranged substantially in parallel and encased in the conductive compound.

Some embodiments may utilize multiple composite core electrodes, for example, to produce an EL wire having two (or more) composite core electrodes which may be joined by a strip of non-conductive polymer. For example, dielectric, electroluminescent and transparent electroconductive layers may be consecutively applied to the entire structure. Above or over the transparent electroconductive layer, at least one extrusive polymer layer may be applied to isolate current-carrying elements of the EL cable from its surroundings.

In some embodiments, a wire contact with the transparent electroconductive layer may not be required. The electroluminescent layer may emit light at the application of alternating voltage of the corresponding frequency and amplitude between the two composite core electrodes. Some embodiments may allow, for example, to produce and/or utilize long or very long pieces of EL wire. For example, the length of the EL wire of a structure may be limited by the maximal admissible current density through the electrodes; and the cross-section of the core electrodes may allow to utilize EL wire sections having lengths of several hundreds of meters.

In some embodiments, for example, an electroluminescent cable may include: a composite core electrode including an elongated flexible metal portion substantially surrounded by one or more layers of a flexible conductive compound, the composite core electrode surrounded by a dielectric layer, an electroluminescent layer, a transparent conductive layer, and a polymer layer.

In some embodiments, for example, the conductive layer is adjoined by a wire contact to an external electrode of the electroluminescent cable.

In some embodiments, for example, the elongated flexible metal portion of the composite core electrode may include a plurality of filaments in electrical communication with each other by the conductive compound.

In some embodiments, for example, the flexible conductive compound may include a powdered dispersion of conductive particles and a polymer.

In some embodiments, for example, the conductive particles may include metal particles.

In some embodiments, for example, the conductive particles may include carbon particles.

In some embodiments, for example, the carbon particles may include nanotubes.

In some embodiments, for example, the conductive particles may include doped semiconductor particles.

In some embodiments, for example, the doped semiconductor particles may include doped ZnO particles.

In some embodiments, for example, the conductive particles may include dielectric particles coated with a conductive layer.

In some embodiments, for example, the dielectric particles may include microscopic mica plates coated with the conductive layer.

In some embodiments, for example, the dielectric particles may include microscopic glass beads coated with the conductive layer.

In some embodiments, for example, the conductive particles may include particles of a conductive polymer.

In some embodiments, for example, the particles of conductive polymer may include PEDOT particles.

In some embodiments, for example, the particles of conductive polymer may include polyaniline particles.

In some embodiments, for example, the polymer may include a polymer selected from a group consisting of: polyolefines, polyolefines copolymers, fluorocarbon polymer, polyamides, copolymer of polyamide, polyurethanes, copolymer of polyurethane, and PVC.

In some embodiments, for example, an external layer of the composite core electrode may include light-reflective particles.

In some embodiments, for example, the light-reflective particles may include conductive ZnO particles.

In some embodiments, for example, a cross-section of the composite core electrode may be substantially circular, non-circular, oval, semi-circular, or the like. Other suitable shapes may be used.

In some embodiments, for example, the filaments are substantially equally spaced.

Some embodiments may include, for example, an electroluminescent cable including: first and second generally parallel composite core electrodes, each of the first and second composite core electrodes including an elongated flexible metal portion substantially surrounded by one or more layers of a flexible conductive compound and electrically insulated from the other, the first and second composite core electrodes jointly surrounded by a dielectric layer, an electroluminescent layer, a transparent electroconductive material layer, and a polymer layer.

In some embodiments, for example, the first and second composite core electrodes are separated by a dielectric material.

Some embodiments may include, for example, a method for fabricating an electroluminescent cable, the method including: providing a composite core electrode including a flexible metal base surrounded by one or more layers of a flexible conductive compound; and successively surrounding the composite core electrode by a dielectric layer, an electroluminescent layer, a transparent electroconductive material layer, a wire contact adjoining the transparent electroconductive material layer, and a polymer layer.

In some embodiments, for example, providing the composite core electrode may include manufacturing the composite core electrode using an extrusion process.

Embodiments of the invention may provide additional and/or other benefits or advantages.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic illustration of a composite core for an electroluminescent electrode in accordance with some embodiments of the invention;

FIG. 2 is a schematic illustration of cross-sectional cut of an electroluminescent cable in accordance with an embodiment of the invention;

FIG. 3 is a schematic illustration of a cross-sectional cut of a composite core electrode in accordance with another embodiment of the invention;

FIG. 4 is a schematic illustration of a cross-sectional cut of a composite core electrode in accordance with yet another embodiment of the invention;

FIG. 5 is a schematic illustration of a cross-sectional cut of a composite core electrode in accordance with still another embodiment of the invention;

FIG. 6 is a schematic illustration of a cross-sectional cut of a composite core electrode in accordance with another embodiment of the invention;

FIG. 7 is a schematic illustration of a cross-sectional cut of a composite core electrode in accordance with yet another embodiment of the invention; and

FIG. 8 is a schematic illustration of a cross-sectional cut of a composite core electrode in accordance with still another embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements throughout the serial views.

### DETAILED DESCRIPTION OF THE INVENTION

In the following detailed description, numerous specific details are set forth in order to provide a thorough understanding of the present invention. However, it will be understood by those skilled in the art that the present invention may be practiced without these specific details. In other instances, well-known methods, procedures, and components have not been described in detail so as not to obscure the present invention.

FIG. 1 schematically illustrates a composite core electrode 5, which may include a copper wire 2 and a conductive compound layer 4, in accordance with some embodiments of the invention. The copper wire 2 may be, for example, approximately 0.5 millimeter in diameter. The concentric conductive compound layer 4 may have a thickness of, for example, approximately 0.5 millimeter thick. In some embodiments, thus, the external diameter of the composite core electrode 5 may be approximately 1.5 millimeter.

The conductive compound 4 may include, for example, PVDF copolymer and carbon black in different forms, including, for example, carbon nanotubes. The content of carbon black may have a weight-to-weight (w/w) ration of, for example, approximately 15 percent. The conductive compound 4 may be applied to the copper wire 2, for example, using an extrusion method; in some embodiments, compression coating and/or coating by a free flow may be used.

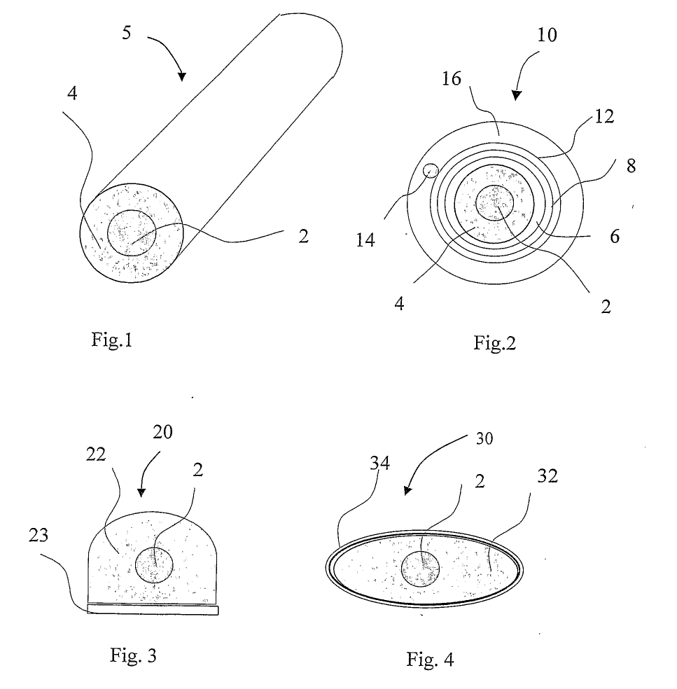

FIG. 2 schematically illustrates a cross-sectional cut of an electroluminescent cable 10 which may include, or a may use as a basis, the composite core electrode 5. In some embodiments, for example, three layers may be successively applied, e.g., layer above layer on the surface of conductive compound 4, for example, using a dip coating method or other suitable methods. In some embodiments, for example, a first layer may include a dielectric layer 6 of barium titanate dispersion in PVDF, having a thickness of approximately 20 to 30 microns; a second layer may include an electroluminescent layer 8 of ZnS:Cu powder dispersion in PVDF, having a thickness of approximately 30 to 50 microns; and a third layer may include an electroconductive layer 12 of a dispersion of microscopic mica plates coated with antimony tin oxide (ATO) in PVDF, having a thickness of approximately 5 to 10 microns.

In some embodiments, a wire contact 14 may be formed of silvered copper wire, may be approximately 0.2 millimeters in diameter, and may be adjacent to the surface of electroconductive layer 12. The wire contact 14 may be pressed to the surface of electroconductive layer 12, for example, using a substantially transparent polymer layer 16. Polymer layer 16 may have a thickness of approximately one millimeter, may be made of polyamide, and may be applied by means of an extruder.

In some embodiments, the electroluminescent cable 10 may be highly flexible. In some embodiments, the electroluminescent cable 10 may be approximately 4 millimeters in diameter, and its weight may be smaller than 30 grants per meter.

In some embodiments, upon the application of alternating voltage to copper wire 2 and wire contact 14 of electroconductive layer 12, the electroluminescent cable 10 emits light. The electroluminescent cable 10 may be efficient within a broad range of parameters of the applied electric signals. In some embodiments, for example, for a sinusoidal signal, frequencies that may be used may include frequencies in a range from approximately 50 Hz to approximately 5,000 Hz, and RMS voltage from 60 V to 230 V.

In some embodiments, for example, using domestic mains as an alternating voltage source (e.g., 220 V, 50 Hz), the luminous flux emitted by one meter of electroluminescent cable 10 may be approximately one lumen. In some embodiments, for example, when operated by a driver generating a sinusoidal signal with a frequency of approximately 4,000 Hz at RMS voltage equal to 130 V, the luminous flux emitted by one meter of electroluminescent cable 10 may be greater than ten lumen.

In other embodiments of the electroluminescent cable 10, both the wire 2 and the wire contact 14 may be multifilament. This may allow, for example, further increase in the flexibility of the electroluminescent cable 10, and/or may allow its mechanical properties to be comparable with or similar to those of a household electric cable.

In some embodiments, the extrusion method of applying conductive compound on copper wire may be utilized for producing composite core electrodes with substantially any cross-section shape.

FIG. 3 schematically illustrates a cross-sectional cut of a composite core electrode 20 in accordance with some embodiments of the invention, the cross-sectional cut having a demonstrative shape close approximately to a semicircle, and having an electrically insulated flat part of the surface. For example, a conductive compound 22 representing PVDF copolymer and carbon black may be applied on copper wire 2, for example, by an extrusion method. The average thickness of layer 22 may be approximately 0.7 to 0.9 millimeters. A layer 23 of nonconductive compound, for instance, PVDF copolymer without additives, may be applied to the flat facet of conductive compound 22. The layer 23 may be, for example, 0.3 to 0.5 millimeters thick. The shape of the conductive compound cross-section may be (e.g., substantially completely) determined using tooling available, for example, in the extruder head. In some embodiments, the entire structure of composite core electrode 20 may be produced in a single technological process on a tandem extrusion line. For example, on a first extruder of the tandem extrusion line, conductive compound 22 may be applied on wire 2; and on a second extruder of the tandem extrusion line, layer 23 of nonconductive compound may be applied on the flat facet of conductive compound 22.

FIG. 4 schematically illustrates a cross-sectional cut of a composite core electrode 30 having a shape close to elliptical, in accordance with some embodiments of the invention. Composite core electrode 30 may include multiple elements, for example, three elements: copper wire 2, a conductive compound 32, and a reflective layer 34 having a high dielectric permittivity.

In some embodiments, conductive compound 32 may be applied to copper wire 2 using an extrusion method. A thin (e.g., approximately 10 to 15 microns) light-reflecting layer 34 having a high reflection factor (e.g., approximately 85 percent) and a high dielectric permittivity (e.g., approximately above 500) may be applied to the surface of conductive compound 32, for example, using a dip coating method. The thin light-reflecting layer 34 may be produced, for example, by applying a dispersion of a mixture of electroconductive ZnO powder and TiO2 powder in PVDF. In some embodiments, electrical conductivity of ZnO may be achieved by its doping. Some embodiments may utilize, for example, ZnO which may be commercially available, for example, produced by HAKUSUI Ltd. In some embodiments, a high dielectric permittivity of layer 34 may be due to the conductivity of ZnO particles, whereas its high reflection factor may be due to the presence of both ZnO and TiO2. In some embodiments, the ratio of the amounts of ZnO and TiO2 by weight may be, for example, approximately 1 to 3; other suitable ratios may be used.

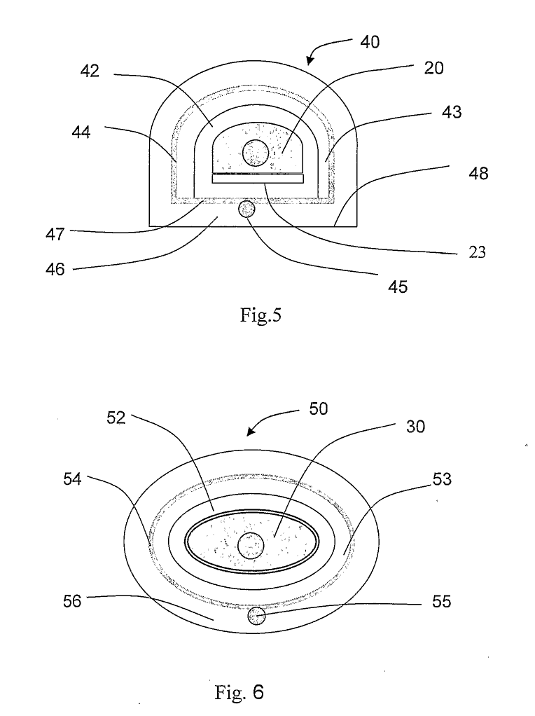

FIG. 5 schematically illustrates a cross-section of an EL cable 40 in accordance with some embodiments of the invention. The EL cable 40 may be used, for example, for fastening to the surface of one or more objects, e.g., for fastening an object to a wall or to another object. In some embodiments, for example, the EL cable 40 may include composite core electrode 20 of FIG. 4.

A dielectric layer 42 may be applied to substantially the entire surface of composite core electrode 20, e.g., including the surface of insulating layer 23. The next layer, an electroluminescent layer 43, may be applied to substantially the entire surface of dielectric layer 42, e.g., except the flat facet. A transparent electroconductive layer 44 may then be applied; and a wire contact 45 may be pressed to the transparent electroconductive layer 44. For example, wire contact 45 may pass along a flat facet 47. An external polymer layer 46 may be used, for example, made of transparent PVDF copolymer, e.g., using a compression method ensuring the formation of an external flat facet 48 which may be substantially parallel or generally parallel to flat facet 47 of composite core electrode 20. The flat facet 48 may optionally be coated with, or may include, a glue layer, e.g., for easy fastening of EL cable 40 to various surfaces or objects.

In some embodiments, EL cable 40 may emit light isotropically within an angle of approximately 180 degrees. The amount of light may be large, for example, since wire contact 45 may not shade or obstruct the light. The EL cable 40 may be manufactured comparatively cheaply, for example, since a relatively expensive component of the structure, namely, the electroluminescent layer 43, may be applied only to a part of or a portion of the surface of dielectric layer 42. In some embodiments, layer 23 of nonconductive compound may increase the reliability of EL cable 40, for example, since a dielectric breakdown of layer 42 in the area of the flat facet, where electroluminescent layer 43 is absent, is unlikely to occur. The EL cable 40 may provide additional and/or other benefits or advantages.

FIG. 6 schematically illustrates an EL cable 50 having an elliptical cross-section. For example, the composite core electrode 30 of FIG. 4 may be used as the core electrode of EL cable 50. Multiple layers may be successively applied on composite core electrode 30; for example, the following layers may be consecutively applied: a dielectric layer 52; an electroluminescent layer 53; and a transparent electroconductive layer 54 representing an external electrode.

In some embodiments, for example, a nickel-plated copper wire 55 may function as an electric contact to electroconductive layer 54, and may adjoin the surface of electroconductive layer 54. A wire 55 may be pressed to electroconductive layer 54, for example, using a polymer layer 56. The polymer layer 56, for example, may be made of PVDF copolymer, e.g., to ensure a reliable pressing of wire 55 to electroconductive layer 54. Optionally, over or above polymer layer 56, another polymer layer may be applied, for example, a polymer layer which contains respective dyes changing the luminescence color. When alternating voltage of the corresponding frequency and amplitude is applied to composite core electrode 30 and to the contact of electric wire 55, the EL cable 50 may emit light. In some embodiments, optionally, particles of one or more light-scattering materials (e.g., mica) may be introduced into polymer layer 56. The use of light-scattering additives may allow, for example, a reduction of the luminescence anisotropy due to the elliptical shape of the light-emitting layer.

In some embodiments, EL cable 50 may emit considerably more light than an EL wire having a cylindrical composite core electrode at the same cross-sectional area and, hence, weight. This may be achieved, for example, utilizing the increased light emission area of EL cable 50. A slight light emission anisotropy may be of no significant importance for many applications. However, if required, light emission anisotropy may be significantly reduced or eliminated, for example, by introducing special diffusion particles into the external polymer layer, which may increase light scattering.

In some embodiments, an additional increase in the amount of the light emitted by EL cable 50 may be achieved by using reflective layer 34, which may be applied to the surface of core electrode 30. For example, in one embodiment, despite minor losses associated with voltage drop in reflective layer 34, the reflective layer 34 may increase brightness by approximately 8 to 12 percent.

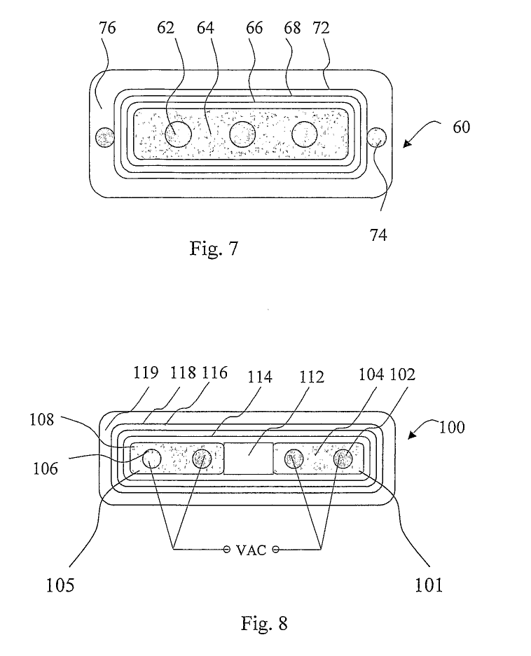

FIG. 7 schematically illustrates a cross-section of EL cable 60 having a ribbon-like shape, in accordance with some embodiments of the invention. In some embodiments, the ribbon width may be practically unlimited. In one embodiment, for example, the composite core electrode may include three copper wires 62, which may be positioned or arranged substantially in parallel and in the same plane within a ribbon-shaped conductive compound 64. Other suitable numbers of wires 62 may be used.

In some embodiments, for example, each one of the three wires 62 may be approximately 0.5 millimeter in diameter, and the three wires 62 may be separated by a distance of approximately 1.5 millimeters; thus, in one embodiment, the composite core electrode may be approximately 7.5 millimeters wide. The conductive compound 64 may be approximately 1.5 millimeters thick, which may ensure a high flexibility of the ribbon. In some embodiments, ribbons of various other widths may be produced, for example, by increasing the number of wires 62, while optionally keeping the spacing among them unchanged. A dielectric layer 66, an electroluminescent layer 68, and a transparent electroconductive layer 72 may be successively applied on the surface of conductive compound 64. At the end-faces of the ribbon, wire contacts 74 may be pressed to transparent electroconductive layer 72. Contacts 74 may be pressed to the surface of transparent electroconductive layer 72, for example, using a transparent polymer coating 76.

FIG. 8 schematically illustrates an EL cable 100 in accordance with some embodiments of the invention. EL cable 100 may include, for example, two composite core electrodes 101 and 105, which may be separated by an insulator 112. Composite core electrode 101 may include two copper wires 102, e.g., arranged within a conductive compound 104. Similarly, composite core electrode 105 may include two copper wires 106, e.g., arranged within a conductive compound 108. Composite core electrodes 101 and 105 may be connected by a strip of nonconductive polymer (PVDF) 112.

In some embodiments, the entire structure including the two composite core electrodes 101 and 105 and the insulating polymer 112 between them may be produced, for example, as a substantially continuous band using a single technological process, e.g., utilizing a co-extruder equipped with suitable facilities.

In some embodiments, on the surface of the structure including the two composite core electrodes 101 and 105 and the polymer (e.g., dielectric strip) 112 uniting them, multiple layers may be applied, for example: a dielectric layer 114; an electroluminescent layer 116; a transparent electroconductive layer 118; and an external insulating layer 119.

In some embodiments, alternating voltage may be applied to the composite core electrodes 101 and 105. The structure of FIG. 8 may allow, for example, to use very long pieces of EL wire 100. For example, the maximal length of a luminous segment of EL wire may be determined using the maximal admissible current flowing through electrodes and contacts. The magnitude of the maximal admissible current through an electrode may be increased by increasing the cross-section of the electrode. An increase in the maximal length of EL wire 100 in comparison with the maximal length of EL wire 10 may be proportional to the ratio of cross-sectional areas of two copper wires 102 and wire contact 14. For example, the diameter of wire 102 may be approximately 0.5 millimeter, and its cross-section may be approximately 0.2 square millimeters; for two wires 102 arranged within the same composite core electrode 101, the cross-sectional area may be doubled and may amount to approximately 0.4 square millimeters. The cross-section of wire contact 14, which may be approximately 0.2 millimeter in diameter, may be approximately 0.3 square millimeters. Thus, in one embodiment, the maximal length of EL wire 100 may exceed 13-fold the maximal length of EL wire 10.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. An electroluminescent cable comprising:
a composite core electrode including an elongated flexible metal portion substantially surrounded by one or more layers of a flexible conductive compound,
the composite core electrode surrounded by a dielectric layer, an electroluminescent layer, a transparent conductive layer, and a polymer layer.

2. The electroluminescent cable of claim 1, wherein the conductive layer is adjoined by a wire contact to an external electrode of said electroluminescent cable.

3. The electroluminescent cable of claim 3, wherein the elongated flexible metal portion of said composite core electrode comprises a plurality of filaments in electrical communication with each other by said conductive compound.

4. The electroluminescent cable of claim 1, wherein the flexible conductive compound comprises a powdered dispersion of conductive particles and a polymer, wherein the conductive particles comprise particles selected from the group consisting of: metal particles, carbon particles, nanotubes, doped semiconductor particles, and dielectric particles coated with a conductive layer.

5-16. (canceled)

17. The electroluminescent cable of claim 1, wherein an external layer of the composite core electrode comprises light-reflective particles.

18. (canceled)

19. The electroluminescent cable of claim 1, wherein a cross-section of the composite core electrode is substantially circular.

20-21. (canceled)

22. The electroluminescent cable of claim 1, wherein a cross-section of the composite core electrode is substantially semi-circular.

23. The electroluminescent cable of claim 4, wherein the filaments are substantially equally spaced.

24. An electroluminescent cable comprising:
first and second generally parallel composite core electrodes, each of said first and second composite core electrodes including an elongated flexible metal portion substantially surrounded by one or more layers of a flexible conductive compound and electrically insulated from the other,
the first and second composite core electrodes jointly surrounded by a dielectric layer, an electroluminescent layer, a transparent electroconductive material layer, and a polymer layer.

25. The electroluminescent cable of claim 24, wherein said first and second composite core electrodes are separated by a dielectric material.

26-27. (canceled)
